(19) United States
(12) Patent Application Publication
(10) Pub. No.: US 2025/0121342 A1
(43) Pub. Date: Apr. 17, 2025

(54) APPARATUS AND METHOD FOR PROVIDING A REDUCED CEMENTITIOUS MATERIAL

(71) Applicant: FLSmidth A/S, Valby (DK)

(72) Inventors: Iver Blankenberg Schmidt, Skorping (DK); Bjarke Andersen, Koge (DK)

(21) Appl. No.: 18/684,655

(22) PCT Filed: Aug. 15, 2022
(86) PCT No.: PCT/EP2022/072795

§ 371 Date: Feb. 16, 2024

(30) Foreign Application Priority Data
Aug. 16, 2021 (DK) PA202100808

(51) Int. Cl. B01J 8/18; C04B 7/44; C04B 7/47; C04B 7/48

(52) U.S. Cl. CPC B01J 8/1827; B01J 8/1836; C04B 7/44; C04B 7/47; C04B 7/48; B01J 2208/00176

(57) ABSTRACT

A manufacturing apparatus for providing a reduced cementitious material comprising a heating device, a reducing device, and a cooling device. The reducing device has a first end comprising a gas seal and being connected to the heating device, such that a heated cementitious material from the heating device is feedable to the first end of the reducing device substantially without any gas from the heating device entering the reducing device. The reducing device has a second end connected to the cooling device, such that a reduced cementitious material formed in the reducing device is provided to the cooling device. The reducing device further has transporting means configured to transport cementitious material from the first end to the second end and is configured for receiving a reducing agent or a precursor for a reducing agent.

### BACKGROUND

During the green transition in the cement industry, it is desirable to try and reduce the environmental impact of cement production. One way of doing this is to minimize the amount of clinker in the cement meal by replacing some of it by a supplementary cementitious material (SCM) which do not require the same amount of energy as cement clinker and emits less CO₂. A preferred SCM is calcined clay which has cementitious properties.

There are two main drivers for using calcined clay. The first being the availability of clay but lack of limestone in some parts of the world, that makes it highly attractive to produce cement from locally available clay deposits. The other being the huge potential to lower the overall CO₂ emission from cement production significantly, enabling cement producers to offer a cement with lower CO₂ footprint. With increasing CO₂ quota prices and the green agenda, the CO₂ aspect is expected to play a major role in the western world.

One challenge of using calcined clay is the red colorization of the clay when it is exposed to high temperatures at the presence of oxygen. This is due to the presence of iron compounds in the clay which are oxidized in the presence of oxygen to iron oxides. To provide the clay with cementitious properties, it needs to be activated by heating it to an activation temperature, typically in the range of 600° C.-900° C. In a clay calcination system, clay is exposed to high temperatures and excess oxygen to burn the fuel, which turns the clay red. The red color is undesirable to most customers when mixing activated clay with clinker to produce cement, as the market demands grey cement but not red cement.

Several different techniques exist to avoid the reddish colorization of the clay. In EP3218320 B1 the clay is heated to an activation temperature of 600 to 1050° C. at reducing conditions to avoid the oxidation of iron, where after the clay is cooled at reducing conditions.

In U.S. Pat. No. 8,906,155 BB the clay may be calcined at oxidizing conditions, where after the clay is thermally treated at reducing conditions. Subsequently the reduced clay is cooled in a first step at reducing conditions to obtain a stable reduced clay compound and thereafter further cooled.

A similar challenge and solution arise in the production of white cement. To avoid the colorization of cement clinker, the amount of at least the compounds Cr₂O₃, Mn₂O₃, and Fe₂O₃ are kept at low levels compared to that of grey cement clinker.

White cement production therefore requires a “bleaching” and “quenching” process. “Bleaching” involves directing a second flame onto the bed of clinker at reducing condition to reduce Fe(III) to Fe(II). Subsequently, to prevent the re-oxidation of the iron, “quenching” is performed. This consists of rapidly lowering the clinker temperature from 1200° C. to below 600° C. in a few seconds. This usually involves dropping it into water and removing it quickly with a screw or passing it through a curtain of water sprays.

The cooling step at reducing conditions is typically carried out by quenching in water or by spraying water to displace the oxygen and add a carbon source such as oil, to provide the reducing conditions.

The quenching process using water contributes to the relatively poor energy efficiency of the process, since the sensible heat of the clinker is not recycled as in normal clinker manufacturer.

It is therefore desirable to provide a process and an apparatus in which the color of the calcined clay can be controlled/changed and which simultaneously allows for a process in which the power consumption and therefore CO₂ emissions are reduced.

### SUMMARY

With this background, it is therefore an object of the present invention to provide an apparatus, by which it is possible to mitigate some of the drawbacks of the prior art. In a first aspect of the invention, these and further objects are obtained by a manufacturing apparatus for providing a reduced cementitious material, the apparatus comprising:
a heating device, configured for heating a cementitious material precursor to or above an activation temperature to form a cementitious material;
a reducing device configured to accommodate the cementitious material and to allow reduction of said cementitious material;
a cooling device, configured to cool the reduced cementitious material such that at least a portion of the cementitious material is maintained in its reduced state;
wherein the reducing device comprising:
a first end being connected to the heating device and comprising gas sealing means, such that a heated cementitious material from the heating device is feedable to the first end of the reactor substantially without any gas from the heating device entering the reducing device;
a second end being connected to the cooling device, such that reduced cementitious material passed through the reducing device is provided to the cooling device;
transporting means configured to transport cementitious material from the first end to the second end;
and wherein the reducing device further is configured for receiving a reducing agent or a precursor for a reducing agent, whereby a reducing atmosphere is achieved and maintained in the reducing device.

By providing a manufacturing apparatus comprising a gas seal in the first end of the reducing device, it is possible to separate the reducing device from the upstream process equipment. The process gases can therefore not flow from the heating device to the reducing device. The reducing atmosphere in the reducing device may comprise combustible gases such as carbon monoxide and/or mixtures of hydrocarbons as well as non-carbon containing reducing agents like e.g. hydrogen or ammonia. By having the gas seal, it is avoided that the combustible gases flow into the heating device and ignite. The seal thereby provides greater process control and also acts as a safety measure. The retention time and the reducing potential of the reducing atmosphere can be controlled to much greater extent which provides greater utilization of the reducing agent and therefore less required reducing agent or reducing agent precursor. By having a manufacturing apparatus where the heating device, for heat treating or calcining the cementitious material, is separate from the reducing device, for reducing the carbonaceous material, allows for the reducing device to have a much smaller volume compared to if the two process steps where integrated into the same equipment. This additionally contributes to a lower usage of the reducing agent.

The heating device may be suitable for converting the cementitious materials precursors/raw materials into materials with desired cementitious properties. In one or more embodiments the heating device may be a calciner or a kiln.

The cementitious material may be a SCM that has been obtained by activation of a suitable material, [symbol] e.g. by heating to a suitable activation temperature, whereby the desired cementitious properties are obtained, and may be used as a partial substitute of cement clinker.

The cementitious material may alternatively be cement clinker that has undergone a color change into a white color by being treated under reducing conditions. The composition of such cement clinker is well-known to the skilled person and typically has a low content of transition elements compared to that of grey cement clinker.

By the term cementitious material precursor is meant the cementitious material which has not yet been heat treated to provide cementitious properties.

By the term “reduced” cementitious material is meant the heat treated and reduced cementitious material having been heat treated to obtain the desired cementitious properties and subsequently been reduced to a lower oxidation state. Examples of reduced cementitious materials are calcined clay having a grey appearance or cement clinker having a white appearance.

The term activation temperature is used to define a temperature at which the cementitious material may form from the cementitious material precursor. The activation temperature depends on the type of cementitious material to form, e.g. cement clinker or an SCM.

The term reduction temperature is used to define a temperature at which the cementitious material is suitable to undergo a reducing reaction, i.e. where the metal ions (typically iron) are reduced to a lower oxidation state. Typically, reaction occurs in a specific temperature interval and goes faster with increasing temperatures. The reducing temperature depends on the type of cementitious material, the chemical compounds to be reduced, but also the nature of the reducing agent. The reducing temperature is typically lower than the reaction temperature. It is typically a temperature interval in which the cementitious material is reactive and where the reaction rate is adequate. Reducing temperatures at for a given cementitious material and reducing agent would be well-known to the skilled person. At a temperature lower than the reducing temperature, the skilled person would perceive the cementitious material as being stable.

A suitable activation temperature for clay compounds may be between 500° C. and 1100° C., preferably between 700° C. and 900° C., more preferably between 800° C. and 850° C.

A suitable activation temperature for white cement clinker may be between 1300° C. and 1500° C. preferably between 1350° C. and 1450° C.

A suitable reduction temperature for activated clay compounds may be 200° C.-1000° C., preferably 400° C.-900° C., preferably 750° C.-850° C.

A suitable reduction temperature for white cement clinker may be between 500° C. and 1200° C. preferably between 600° C. and 1000° C., more preferably between 800° C. and 900° C.

Depending on the type of reducing agent, the skilled person would be able to determine suitable temperature interval for conducting the chemical reaction to obtain the desired reduced cementitious material.

The cooling device preferably comprises cooling means suitable for heat recuperation. Suitable cooling means may be cooling by gas quenching, such as air quenching. To increase the heat recuperation, it is preferred not to cool by water quenching. Suitable cooling devices may be a gas-suspension preheater such as a cyclone or a fluidized bed cooler. Preferably, the cooling device comprises a plurality of cooling stages, such as from one to five stages. Preferably, the cooling device is configured to cool the reduced cementitious material at oxidizing conditions, but at a cooling rate which is fast enough to cool the cementitious to a temperature below the reduction temperature to maintain at least a portion of the cementitious material in a reduced oxidation state. The cooling rate may be from 25° C./second to 1000 [symbol] ° C./second, preferably from 100° C./second to 300° C./second. Depending on the type of cementitious material, the composition of the cementitious material and the desired color, it is preferred to cool the reduced cementitious material to a temperature of below 500° C., such as 350° C. Calcined clay should typically be quenched to a temperature of 350° C. to substantially maintain a desired color. For white cement, it is preferred to cool the reduced white cement clinker to a temperature lower than 800° C., such as 600° C.

The transporting means is configured to transport the cementitious material from the first end to the second end. Preferably the transporting means is also adapted for mixing the cementitious material in the reducing device to provide better contact between cementitious material and the reducing agent. The transporting means may be a mechanical transporting means such as a rotating shaft comprising blades, a drag chain or a screw conveyor. Alternatively, the transporting means may be non-mechanical transporting means such a fluidizing bed or an air slide where a gas or liquid is utilized to fluidize the cementitious material. A gas may directly fluidize the particles, whereas a liquid should be selected such that it has a boiling point lower than the process temperature, such that it vaporizes when provided to the reducing device. One example of a suitable liquid may be water.

In one or more embodiments, the manufacturing apparatus additionally comprises gas sealing means located in the second end of the reducing device and wherein the second end is connected to the cooling device such that reduced cementitious material passed through the reducing device is provided to the cooler substantially without any gas from the reducing device entering the cooling device.

By having a gas seal in the second end, the reducing atmosphere in the reducing device is completely isolated from upstream and downstream processes. This also prevents combustible gases in the reducing atmosphere from igniting in the cooler where oxygen may be present. Instead the excess gas comprising spend reducing agent may be removed from the reducing device by a dedicated gas outlet. Preferably the gas outlet is arranged and oriented such that cementitious material cannot enter the gas outlet. The excess gas may be added to a preferred location in the heating device, at least partially recycled to the reducing device or used as gaseous fuel in other process.

In one or more embodiments, the reducing device is configured for accommodating a cementitious material in particulate form and the transporting means are adapted to transport the particulate cementitious material from the first end to the second end, while the particulate cementitious material is in a dense phase. By dense phase is meant that the particulate is suspended in a dense suspension without any substantial entrainment of particles typically obtaining bulk densities above 25% of the density of the same material in a completely de-aerated state. Dense phase particulate material is characterized by being substantially non-entrained, i.e. the vertical velocities of the solid particles are lower than the upward velocity of the suspension gases. By dense phase is meant that the particles are not suspended in gas (non-entrained flow).

In one or more embodiments, the reducing device is configured with fluidizing means. Fluidizing means provide excellent mixing of material in the reducing device.

To ensure good fluidization, it is preferred that the cementitious material is in the form of particulates that have a grain size of 1-5000 μm. In one or more embodiments, the manufacturing apparatus comprises grinding means, suitable for downsizing cementitious material to a grain size of 1 to 500 μm.

In one or more embodiments, the fluidizing means is configured to fluidize by means of pulses of gas or liquid. Pulsation of gas utilizes less gas to obtain fluidization of particulates. Less gas will therefore have to be heat exchanged and cleaned. Fluidization by pulsation therefore provides a more cost efficient and more environmentally friendly fluidization compared to a constant gas flow. The pulses are provided at frequencies of 0.1 to 10 Hz and at pressures of 0.5 to 7 bar.

By providing the reducing device with fluidizing means allows the gas seal to be in the form of a loop seal. By having a particulate cementitious material behaving as a fluid allows the cementitious material to flow through the loop seal while being fluidized, but substantially prevents any process gas from the heating device entering the reducing device. Alternatively, the gas sealing means may be a screw feeder.

Reducing agent may be introduced into the reducing device through the gas seal, which is located in the first end, as a precursor. By a reducing agent precursor is meant a component which is converted into the actual reducing agent. An example may be solid coal which in the reducing chamber is converted into carbon monoxide by coming into contact with the heated cementitious material. The reducing agent may be selected from the list comprising: coal, waste fuel, petroleum product, pet coke, biomass, carbon-containing gas, hydrogen, ammonia and ammonia-forming precursors like e.g. urea.

In one or more embodiments, the reducing device comprises a reducing agent inlet, adapted to provide a solid, liquid or gaseous reducing agent or reducing agent precursor. The reducing agent inlet may be located in the reducing device such that the cementitious material comes into contact with the reducing agent while being transported from the first end to the second end.

In one or more embodiments, the reducing device is configured as a loop seal. The reducing device may e.g. have U-shape, V-shape, W-shape or another shape which prevents a gas from flowing from the first end to the second end which the loop seal comprises a fluidized particulate material. In the loop seal configuration the reducing device has a first end and second end separated by a sealing portion which during use is filled with fluidized particulate material such that gas is prevented from flowing from the first end to the second end. The fluidized particulate material flows from the first end to the second end due to the weight of the particulate material entering in the first end and which forces material through the loop seal and towards the second end.

According to another aspect, the invention relates to a method of manufacturing a reduced cementitious material. The method comprising the steps of:
providing a cementitious material precursor comprising a transition element and having an activation temperature;
heat treating the cementitious material precursor at oxidizing conditions to or above the activation temperature to form the cementitious material;
providing the cementitious material to a reducing device without substantially providing any process gas from the heat treating step and maintaining the temperature of the cementitious material at or above a reduction temperature;
providing a reducing agent or a precursor for a reducing agent to the reducing device and contacting the cementitious material with the reducing agent to provide a reduced cementitious material;
cooling the reduced cementitious material under oxidizing conditions to a temperature below the reduction temperature to provide a cooled reduced cementitious material.

The cementitious material comprising a transition element may be white cement clinker or an activated clay comprising Iron, Manganese, Vanadium, Chromium or other transition element oxides which experience a color change from an oxidized to a reduced condition.

The step of providing the cementitious material to a reducing step is carried out after the step of heat treating the cementitious material precursor. I.e. the steps are carried out separately, in separate process equipment.

Cooling under oxidizing conditions is preferably carried by air quenching or at least partially by mixing with cooled solids. The cooling rate influence the final color of the cementitious material, since some of the reduced cementitious material may oxidize if the reaction is not fast enough. By the term reduced cementitious material is meant a cementitious material which has undergone a reduction reaction. By cooling in oxidizing conditions some of the reduced cementitious material may re-oxidize, but the cooled reduced cementitious material should have an average oxidation state lower than the oxidation state of the heat treated cementitious material. In the particular application, this provides a color different from that of the oxidized cementitious material. Depending on the preferred color control, it may be sufficient and preferred that at least 50 w/w % of the reduced cementitious material are in an oxidation stage lower than the heat treated cementitious material, preferably 60 w/w %, preferably 70 w/w %, preferably 80 w/w %, preferably 90 w/w %, preferably 95 w/w %.

In one or more embodiments, the reduced cementitious material is provided to a cooling device substantially without any reducing agent where the reduced cementitious material is subject to the cooling step.

In one or more embodiments, excess gas from the reducing device is provided to the heat treating step. The excess gas may be reducing agent provided to the reducing device, a gas formed in the reducing device, such as carbon monoxide, partially oxidized hydrocarbons, water (steam). By having a reducing device which is substantially isolated from process gas from other process steps the excess gas is not diluted by e.g. air, and may thus be utilized in the heating step as a fuel. Examples of excess gas are: carbon monoxide and partially oxidized hydrocarbons.

In one or more embodiments, the cementitious material is provided as a particulate material and wherein the cementitious material is fluidized in the reducing device. This provides good mixing properties of the cementitious material and therefore good contact between the cementitious material and the reducing agent.

In one or more embodiments, the reduced cementitious material is white cement clinker.

In one or more embodiments, the reduced cementitious material is calcined clay having a grey appearance.

Further presently preferred embodiments and further advantages will be apparent from the following detailed description and the appended dependent claims.

### FIGURES

The invention will be described in more detail below by means of non-limiting examples of presently preferred embodiments and with reference to the schematic drawings, in which:

FIG. 1 shows an overview of a manufacturing apparatus comprising a reducing device according to an embodiment of the invention;

FIG. 2 shows a schematic drawing of a reducing device according to an embodiment of the invention;

FIG. 3 shows a schematic drawing of a reducing device according to another embodiment of the invention.

### DETAILED DESCRIPTION

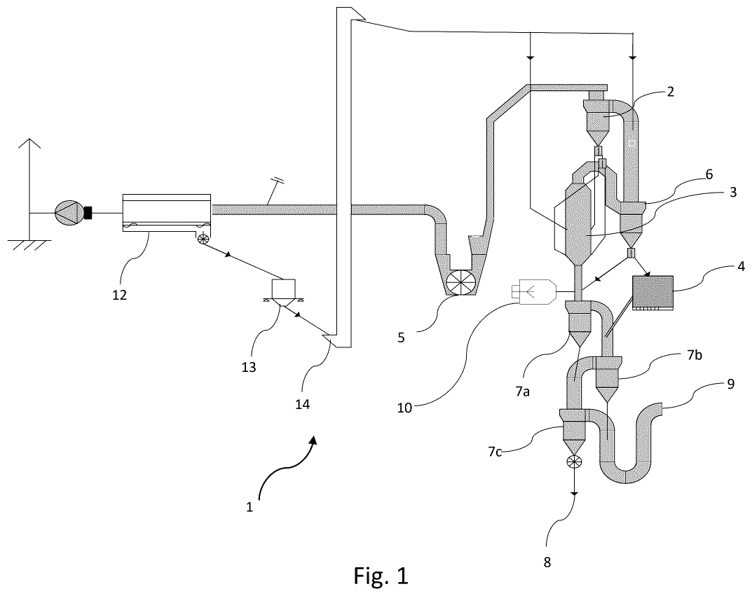

FIG. 1 shows a manufacturing apparatus 1 for manufacturing a reduced cementitious material. A cementitious material precursor in the form of a clay mineral containing compound or clinker precursor (Limestone, silica/sand, alumina source, such as kaolinitic clay), is provided to a crusher 5 for drying by utilizing hot process gas and downsizing. The precursor material is then provided to a filter device 12 and further into a dosing device in the form of a hopper 13. From the hopper 13, the precursor material may be added in a desired amount into the pyro process system through the material elevator 14. The precursor material is then provided to the heating devices in the form of the preheating cyclone 2 or alternatively to the calciner 3. From the preheating cyclone 2 preheated precursor material may be added to different locations in the calciner 3 to regulate and provide a desired temperature profile. The calciner 3 operates under oxidizing conditions and the precursor material is activated (reacted) to form an oxidized cementitious material. The oxidized cementitious material is then provided to the cyclone separator 6 where it may be recirculated to the calciner for temperature control of the calciner, or to the reducing device 4, in which the oxidized cementitious material is reduced to a lower oxidation state. The reduced cementitious material is then provided to the cooling device in the form of a three stage cooling cyclone 7a, 7b, 7c, where the reduced cementitious material is cooled by air quenching to a temperature below a reducing temperature and thereby to provide a stable cementitious material which has an average oxidation stage lower than the oxidized cementitious material. The final product may be removed from the lowest cooling cyclone stage though the material exit 8. Ambient air is added through the gas inlet 9 and is provided in counterflow to the solid material. The ambient air will heat as it contacts the hot reduced cementitious material in the cooling cyclones 7a, 7b, 7c. Additional heat energy may be provided to the air utilizing the hot gas generator 10 before the gas is added to the calciner 3.

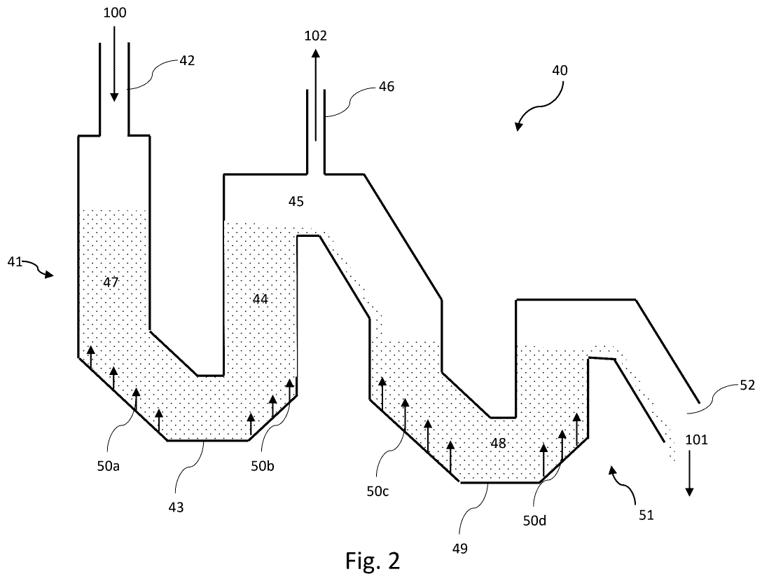

Turning now to FIG. 2 showing a reducing device 40 according to one embodiment in greater detail. The reducing device 40 has a first end 41 having a gas seal in the form of a loop seal arrangement 43 formed by the substantial U-shape. The first end 41 comprises an inlet 42 which is connected to the heating device, such that a heated cementitious material from the heating device is feedable to the first end of the reactor. Any gas provided from the heating device 3 will not be able to pass the loop seal arrangement and process gas from the heating device 3 cannot enter the reducing zone 45. A number of fluidization means, in the form of gas nozzles are located along the lower surface of the reducing device 40 for injecting a fluid 50 and thereby fluidize the cementitious material. In the embodiment shown the reducing agent is injected together with the fluid 50b to form the powder column 44 comprising fluidized cementitious material and reducing agent. Spent or excess reducing agent is comprised in the outlet gas 102 and may be removed through the gas outlet 46 and may optionally be provided to the burner in the calciner. The gas outlet 46 may comprise gas analyzing means to analyze the content of reducing agent in the outlet gas, and thereby regulate the amount of reducing agent added to the reducing device 40. The reducing zone 45 is isolated between the first end 41 and the second end 51 and is therefore configured for providing and maintaining a reducing atmosphere. The second end 51 has a gas seal in the form of a loop seal arrangement 49 formed by the substantial U-shape. Due to the material column 48 of fluidized reduced cementitious material the outlet gas 102 cannot flow through the loop seal arrangement 49 to the cooling device 7. The reduced cementitious material 101 is removed through the outlet 52. The fluidizing fluid 50 may be different types of gas or liquid. The fluid provided as 50a, 50b, 50c and 50d may be the same fluid or different fluids. As an example the fluid 50a may be air, whereas the gas 50c and 50d may be an inert gas such as N₂. A gas comprising a reducing agent may be provided as the fluid 50b. Alternatively a liquid may be provided such that the liquid evaporates in the process environment and provides steam as the fluidizing gas. By providing fluidizing fluids and fluidizing the cementitious material, the cementitious material is transported through the reducing device 40. The weight of the first material column 47 forces the cementitious through the reducing device 40.

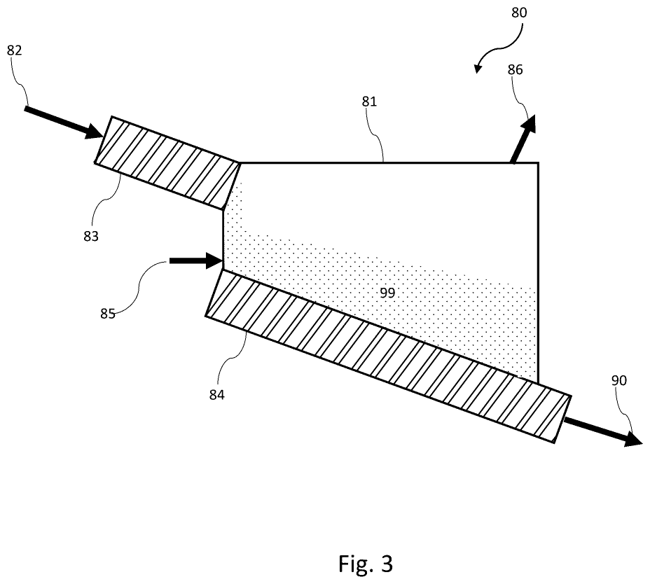

Turning now to FIG. 3 showing another embodiment of a reducing device 80. The reducing device 80 works by the same principles as the reducing device 40, but without the provision of gas for fluidizing the cementitious material. The reducing device 80 comprises a reducing vessel 81 configured for receiving and accommodating a cementitious material and a reducing atmosphere. An inlet 82 is located in the first end of the reducing device 80. A gas seal in the form of a screw feeder 83 provides cementitious material to the reducing vessel 81 substantially without providing any process gas from the heating device.

A material outlet 90 is located in the second end of the reducing device 80. The material outlet 90 is isolated from the reducing vessel 81 by means of a screw feeder 84 which also provides transportation and [symbol] mixing of the cementitious material 99 from the first end to the second end. The reducing device 80 is configured for receiving a reducing agent or a precursor for a reducing agent through the inlet 85. An outlet gas comprising spend reducing agent is removed from the reducing vessel 81 through the gas outlet 86.

1. A manufacturing apparatus for providing a reduced cementitious material, the apparatus comprising:
a heating device, configured to heating a cementitious material precursor to or above an activation temperature;
a reducing device configured to accommodate the cementitious material and to reduce said cementitious material;
a cooling device, configured to cool the reduced cementitious material such that the cementitious material is at least partially maintained in its reduced state;
wherein
the reducing device comprising:
a first end being connected to the heating device and comprising gas sealing means, such that a heated cementitious material from the heating device is feedable to the first end of the reducing device substantially without any gas from the heating device entering the reducing device;
a second end connected to the cooling device, such that reduced cementitious material passed through the reducing device is provided to the cooling device;
transporting means configured to transport cementitious material from the first end to the second end;
and wherein the reducing device further is configured for receiving a reducing agent or a precursor for [symbol] a reducing agent, whereby a reducing atmosphere is achieved and maintained in the reducing device.

2. The manufacturing apparatus for providing a reduced cementitious material according to claim 1, wherein the second end being connected to the cooling device and comprising gas sealing means such that reduced cementitious material passed through the reducing device is provided to the cooler substantially [symbol] without any gases from the reducing device entering the cooling device.

3. The manufacturing apparatus for providing a reduced cementitious material according to claim 1 or 2, wherein the reducing device and the transporting means are configured for accommodating a cementitious material in powder form and wherein the cementitious material is transported from the first end to the cement end in a dense phase.

4. The manufacturing apparatus for providing a reduced cementitious material according to any previous claim, wherein the reducing device further is configured with fluidizing means.

5. The manufacturing apparatus for providing a reduced cementitious material according to any [symbol] previous claim, wherein the fluidizing means is configured to fluidize by means of pulses of gas or liquid.

6. The manufacturing apparatus for providing a reduced cementitious material according to any previous claim, wherein the gas sealing means is a loop seal.

7. The manufacturing apparatus for providing a reduced cementitious material according to claims 4 to 6, wherein the reducing device is configured as a loop seal.

8. The manufacturing apparatus for providing a reduced cementitious material according to any previous claim further comprising a gas outlet for removing an excess amount of gas comprising spend [symbol] reducing agent from the reducing device, and optionally wherein the excess amount of gas is provided to the heating device.

9. The manufacturing apparatus for providing a reduced cementitious material according to any previous claim, wherein the cooling device is configured to cool at oxidizing conditions, preferably by air [symbol] quenching.

10. The manufacturing apparatus for providing a reduced cementitious material according to any previous claim, wherein the cooling device comprises a plurality of cooling stages, such as from one to five stages.

11. A method of manufacturing a reduced cementitious material, the method comprising the steps of:
providing a cementitious material precursor comprising a transition element and having an activation temperature;
heat treating the cementitious material precursor at oxidizing conditions to or above the activation temperature to form the cementitious material;
providing the cementitious material to a reducing device without substantially providing any process gas from the heat treating step and maintaining the temperature of the cementitious material above a reduction temperature;
providing a reducing agent or a precursor for a reducing agent to the reducing device and contacting the heated cementitious material with the reducing agent to provide a reduced cementitious material;
cooling the reduced cementitious material under oxidizing conditions to a temperature below the reduction temperature to provide a cooled reduced cementitious material.

12. The Method according to claim 11, wherein the reduced cementitious material is provided to a cooling device substantially without any reducing agent.

13. The Method according to claim 11 or 12, wherein any excess gas developed in the reducing device is provided to the heat treating step.

14. The Method according to claims 11 to 13, wherein the cementitious material is provided as a powder and wherein the cementitious material is fluidized in the reducing device.

15. The method according to claims 11 to 14, wherein the cementitious material is white cement clinker, preferably crushed or ground white cement clinker.

16. The method according to claims 11 to 14, wherein the cementitious material is a thermally activated clay mineral containing compound.
